(19) United States
(12) Patent Application Publication
(10) Pub. No.: US 2009/0043808 A1
(43) Pub. Date: Feb. 12, 2009

(54) IMAGE PROCESSING APPARATUS AND IMAGE PROCESSING METHOD

(75) Inventor: Michihiko Yamada, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/186,843

(22) Filed: Aug. 6, 2008

(30) Foreign Application Priority Data
Aug. 8, 2007 (JP) 2007-207155

(51) Int. Cl. G06F 17/30; G06F 7/00

(52) U.S. Cl. 707/102; 707/3; 707/E17.005

(57) ABSTRACT

An image processing apparatus includes a segmentation unit configured to segment input image data into a plurality of objects, a generation unit configured to generate data having a format including the image data and metadata for the image data, and a registration unit configured to register, in the metadata, an identifier for a user with respect to either of the image data or the object based on a user instruction.

### BACKGROUND OF THE INVENTION

1. Field of the Invention

The present invention relates to an image processing apparatus and an image processing method capable of performing a search based on an identifier and data management using a common data format generated thereby and an identifier embedded in data.

2. Description of the Related Art

Conventionally, users desire to produce a book including favorite pages selected from data spooled on a network-connected apparatus. Further, it is conventionally desired to generate a new page having objects included in other existing pages (a character string, a graphic, or an image included in an existing page).

If, in this case, a user desires to combine and edit favorite pages or objects selected by viewing data listed on a preview screen, then the following problem may arise when a number of pages or objects or a number of files including such pages is large. That is, the user may not easily remember later which pages or objects have been selected to be combined or edited.

Furthermore, in the case where a plurality of users uses shared data or cooperatively works, it is desired to combine or edit the data commonly selected by a user and other concerned users or to combine or edit all data selected by each user.

On the other hand, Japanese Patent Application Laid-Open No. 2000-123048 discusses a method for allowing a user to make an inquiry as to a document, rebuild a data structure for the document, share information about document data and related data, and view the data as a list by making and referring to a database including bookmarks. In this method, each data is assigned to an individual user, each project, each group, or each department, which are hierarchically assigned and held.

However, in this method, if the database itself is broken, it is necessary to newly generate a database. Furthermore, if the data has been erased by mistake, a user cannot perform a search.

Furthermore, in the case of deleting data or moving a data storage location, it is necessary to search all the databases in which the data has been registered to delete the concerned information. Moreover, while it is relatively easy to generate a database of files or web pages, it is generally difficult to generate a database of objects (elements) included in a page of a file (for example, a character string, a graphic, and an image).

### SUMMARY OF THE INVENTION

The present invention is directed to an image processing apparatus and image processing method capable of allowing a user to easily perform a search based on an identifier embedded on data having a common format and perform data management.

According to an aspect of the present invention, an image processing apparatus includes a segmentation unit configured to segment input image data into a plurality of objects, a generation unit configured to generate data having a format including the image data and metadata for the image data, and a registration unit configured to register, in the metadata, an identifier for a user with respect to either of the image data or the object based on a user instruction.

According to an exemplary embodiment of the present invention, a user identifier can be easily assigned to image data or an object. Furthermore, according to an exemplary embodiment of the present invention, an identifier is registered in metadata. Thus, it is easy to manage an identifier.

According to an exemplary embodiment of the present invention, since an identifier is registered in metadata, it is not necessary to reconstruct a database even in the case where a database has been broken and thus a data search is not available or where files have been broken or moved.

Moreover, according to the present exemplary embodiment, if search target data is broken, the broken data is automatically excluded from search target data. Accordingly, it is not necessary to reconstruct a database in this case. In addition, according to the present exemplary embodiment, a search can be performed also as to an object included in a page as a search target.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principle of the invention.

FIG. 1 illustrates an example of an image forming apparatus according to an exemplary embodiment of the present invention.

FIG. 2 illustrates a detailed example of the image forming apparatus according to an exemplary embodiment of the present invention.

FIG. 3 is a flow chart illustrating an example of a flow of processing for combining an intermediate language and object information and spooling the resulting data in a data storage system according to an exemplary embodiment of the present invention.

FIG. 4 illustrates an example of a structure of data spooled in the data storage system according to an exemplary embodiment of the present invention.

FIG. 5 illustrates an example of an operation for registering, as information, an identifier (ID) in metadata and deregistering the registered identifier via a graphical user interface (GUI) according to an exemplary embodiment of the present invention.

FIG. 6 illustrates an example of an operation for registering, as information, an ID in metadata and deregistering the registered identifier via a GUI according to an exemplary embodiment of the present invention.

FIG. 7 illustrates an example of an operation for registering, as information, an ID in metadata and deregistering the registered identifier via a GUI according to an exemplary embodiment of the present invention.

FIG. 8 illustrates an example of an operation for registering, as information, an ID in metadata and deregistering the registered identifier via a GUI according to an exemplary embodiment of the present invention.

FIG. 9 illustrates an example of an operation for registering, as information, an ID in metadata and deregistering the registered identifier via a GUI according to an exemplary embodiment of the present invention.

FIG. 10 illustrates an example of an operation for registering, as information, an ID in metadata and deregistering the registered identifier via a GUI according to an exemplary embodiment of the present invention.

FIG. 11 illustrates an example of an operation for registering, as information, an ID in metadata and deregistering the registered identifier via a GUI according to an exemplary embodiment of the present invention.

FIG. 12 illustrates an example of an operation for registering, as information, an ID in metadata and deregistering the registered identifier via a GUI according to an exemplary embodiment of the present invention.

FIG. 13 illustrates an example of an operation for registering, as information, an ID in metadata and deregistering the registered identifier via a GUI according to an exemplary embodiment of the present invention.

FIG. 14 illustrates an example of a flow of processing for searching for a file according to an exemplary embodiment of the present invention.

FIG. 15, which is composed of FIGS. 15A and 15B, is a flow chart illustrating an exemplary flow of processing for searching for a file according to an exemplary embodiment of the present invention.

FIG. 16 illustrates an example of processing for deleting a file spooled in a data storage system according to an exemplary embodiment of the present invention.

FIG. 17 is a flow chart illustrating exemplary processing performed by a multifunction peripheral (MFP) for deleting a file spooled in a data storage system according to an exemplary embodiment of the present invention.

FIG. 18 is a flow chart illustrating exemplary processing performed by an MFP for deleting a file spooled in a data storage system according to an exemplary embodiment of the present invention.

FIG. 19 illustrates an example of processing for deleting an object included in spool data according to an exemplary embodiment of the present invention.

FIG. 20 illustrates an example of processing for deleting an object included in spool data according to an exemplary embodiment of the present invention.

FIG. 21 illustrates an example of processing for deleting an object included in spool data according to an exemplary embodiment of the present invention.

FIG. 22 illustrates an example of processing for deleting an object included in spool data according to an exemplary embodiment of the present invention.

FIG. 23 is a flow chart illustrating an exemplary flow of processing performed by the MFP for deleting an object included in spool data according to an exemplary embodiment of the present invention.

FIG. 24 is a flow chart illustrating an exemplary flow of processing performed by the MFP for deleting an object included in spool data according to an exemplary embodiment of the present invention.

### DETAILED DESCRIPTION OF THE EMBODIMENTS

Various exemplary embodiments, features, and aspects of the present invention will now be herein described in detail below with reference to the drawings. It is to be noted that the relative arrangement of the components, the numerical expressions, and numerical values set forth in these embodiments are not intended to limit the scope of the present invention.

### First Exemplary Embodiment

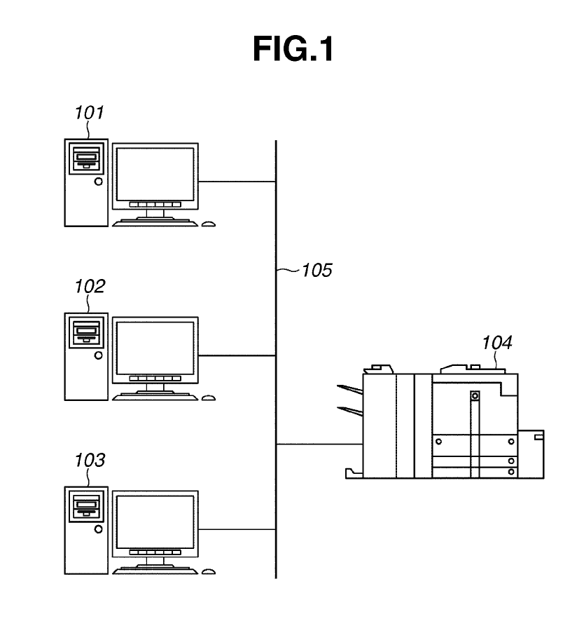

A first exemplary embodiment of the present invention is described below. FIG. 1 illustrates an example of an image forming apparatus (image processing apparatus) according to the first exemplary embodiment of the present invention.

Referring to FIG. 1, client personal computers (PCs) 101 through 103, via each of which a user utilizes an MFP 104, are connected to the image forming apparatus. The MFP 104 is connected to a network 105 and implements various functions (a copy function, a printing function, a send function). The example illustrated in FIG. 1 is a mere example, to which the present invention is not limited. That is, the present invention can also be applied to a multitude of MFPs and client PCs.

Furthermore, terminals of various types used as the client PCs 101 through 103 have standard components that an ordinary all-purpose computer generally has. That is, the client PCs 101 through 103 include a central processing unit (CPU), a random access memory (RAM), a read-only memory (ROM), a hard disk, an external storage device, a network interface, a display, an input unit such as a keyboard, and a pointing device such as a mouse.

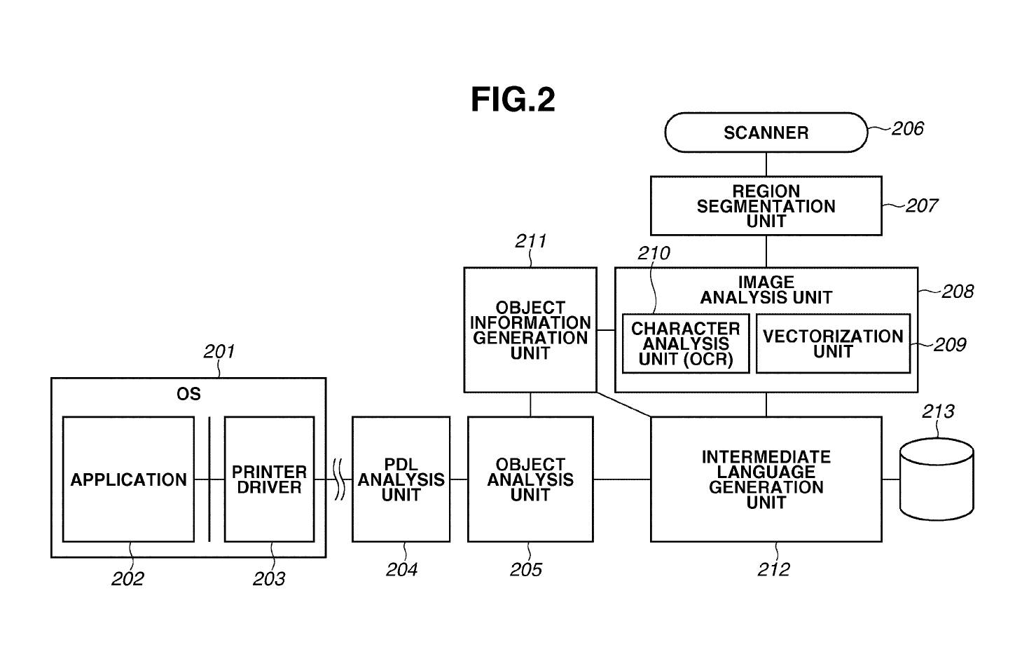

The image forming apparatus is described in detail below with reference to FIG. 2.

Referring to FIG. 2, an operating system (OS) 201 is installed on the client PCs 101 through 103. The OS 201 controls an application 202 and a printer driver 203. Furthermore, units 204 through 213 are included in the MFP 104.

A page description language analysis unit 204 analyzes a page description language (PDL) transmitted from a printer driver 203 via the network 105. The page description language analysis unit 204 identifies and segments an object based on an object attribute such as a character code, a graphic, and a natural image.

An object analysis unit 205 analyzes an object included in a page received from the page description language analysis unit 204 to extract a character code. An object information generation unit 211 generates object information based on a result of the analysis on an object by the object analysis unit 205.

On the other hand, a region segmentation unit 207 analyzes a scanned image read by a scanner 206. The region segmentation unit 207 analyzes what is drawn in which region and performs segmentation into regions (objects) for each attribute such as a character region, a graphics region, or a natural image region. A character analysis unit 210 performs character analysis for character region and performs character analysis on a region of each region-segmented image that has been determined to be a character region by the region segmentation unit 207.

An image analysis unit 208 includes a vectorization unit 209 which performs vectorization processing on a region determined to be a graphics region by the region segmentation unit 207. An intermediate language generation unit 212 generates data described with an intermediate language. A data storage system 213 spools data.

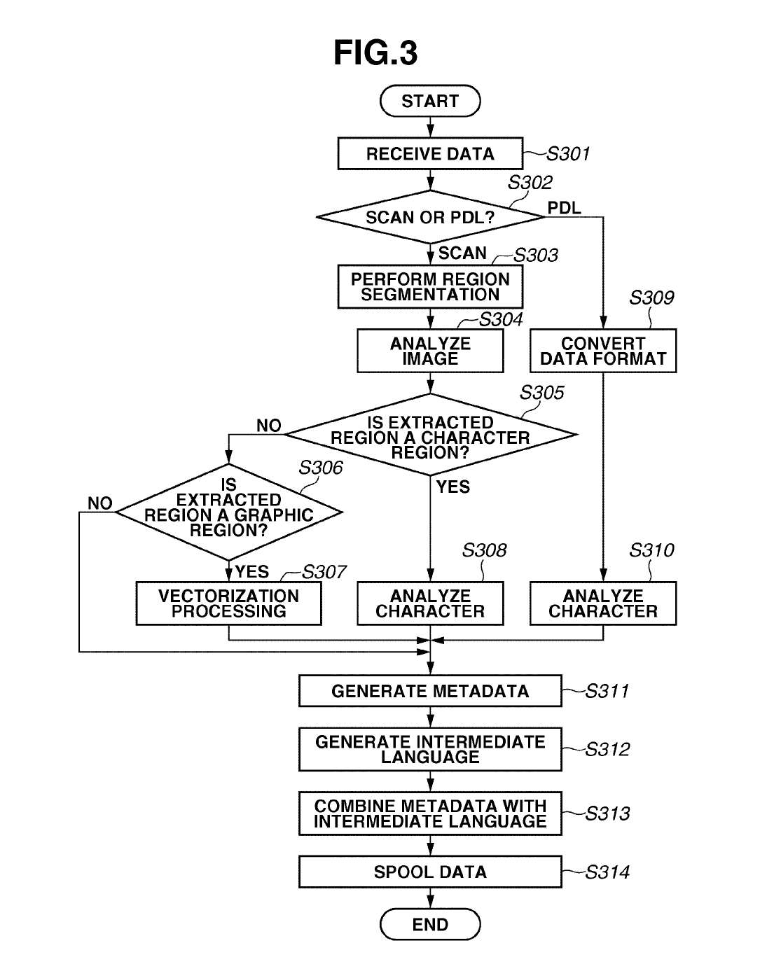

Now, processing performed by the image processing apparatus for combining intermediate language data with object information and spooling the combined data in the data storage system is described with reference to a flow chart of FIG. 3. Processing in each step of the flow chart in FIG. 3, which is described in detail below, is performed by a CPU (not illustrated) of the image forming apparatus (FIG. 1).

Referring to FIG. 3, in step S301, the CPU determines whether data has been received (whether image data has been input). If it is determined in step S301 that data has been received (YES in step S301), then the processing advances to step S302.

In step S302, the CPU determines a type of the input image data (namely, the CPU determines whether the input image data is SCAN data (scanned data) or PDL data). If it is determined in step S302 that the input image data is SCAN data, then the processing advances to step S303. “SCAN data” refers to image data obtained by reading an image of an original document with a scanner. “PDL data” is described with a page description language generated by a PC based on an instruction for printing.

In step S303, the CPU causes the region segmentation unit 207 to perform region segmentation processing for segmenting the read document image into regions such as a character region and a graphics region. Then, the processing advances to step S304.

In step S304, the CPU inputs the data of each region into the image analysis unit 208. Then, the processing advances to step S305.

In step S305, the CPU determines the type of each segmented region (determines whether the region segmented by the region segmentation unit 207 is a character region). If it is determined in step S305 that the region segmented by the region segmentation unit 207 is a character region (YES in step S305), then the processing advances to step S308.

In step S308, the CPU performs a character analysis (character recognition processing) on an image in the character region using the character analysis unit 210 and acquires character code data as a result of the character recognition. Then, the processing advances to step S311. On the other hand, if it is determined in step S305 that the region segmented by the region segmentation unit 207 is not a character region (NO in step S305), then the processing advances to step S306.

In step S306, the CPU determines whether the region segmented by the region segmentation unit 207 is a graphics region. If it is determined in step S306 that the region segmented by the region segmentation unit 207 is a graphics region (YES in step S306), then the processing advances to step S307. In step S307, the CPU performs vectorization processing on the image in the graphics region with the vectorization unit 209. Then, the processing advances to step S311. On the other hand, if it is determined in step S306 that the region segmented by the region segmentation unit 207 is not a graphics region (NO in step S306), then the processing advances to step S311.

On the other hand, if it is determined in step S302 that the input image data is PDL data, then the processing advances to step S309. In step S309, the CPU analyzes the page description language with the PDL analysis unit 204 to identify an object with respect to each attribute such as the character code, graphics, or a natural image. Furthermore, the CPU extracts a character code from the page description language. Then, the processing advances to step S310.

In step S310, the CPU performs a character analysis with respect to an alignment sequence of character codes extracted from the PDL with the object analysis unit 205. Then, the processing advances to step S311. In step S311, the CPU identifies a word and a phrase as a search keyword with the object information generation unit 211 based on a result of the character analysis performed in step S308 or step S310. Furthermore, the CPU generates metadata for the SCAN data or the PDL data based on the identified search keyword. Then, the processing advances to step S312.

In step S312, the CPU generates intermediate language data suitable for use in the image forming apparatus using the intermediate language generation unit 212 based on the SCAN data or the PDL data. Then, the processing advances to step S313.

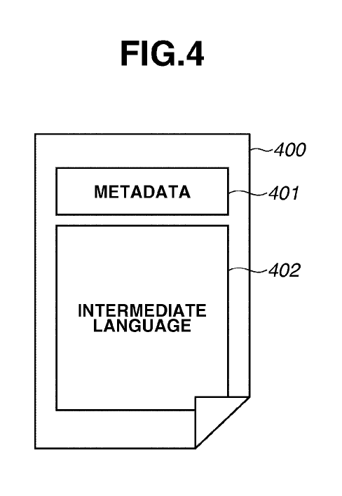

In step S313, the CPU combines the intermediate language data generated using the intermediate language generation unit 212 with the metadata generated by the object information generation unit 211 to generate data 400 (FIG. 4) having a predetermined format. Then, the processing advances to step S314.

In step S314, the CPU stores the data 400 generated by combining the data in step S313 in the data storage system 213. Then, the processing ends.

FIG. 4 illustrates an example of a data structure (a data format) of the data 400 stored in the data storage system 213 according to the present exemplary embodiment. With respect to the data stored in the data storage system 213, both the data that has been generated and stored based on the SCAN data and the data that has been generated and stored based on the PDL data have a common format (data structure).

Referring to FIG. 4, the spool data 400 has the data structure such that metadata 401, which is meta-information generated by the object information generation unit 211, and intermediate language data 402, which has been generated by the intermediate language generation unit 212, are combined therein.

In the present exemplary embodiment, the intermediate language data 402 is image data suitable for processing (printed, displayed, or edited) in the image forming apparatus. Furthermore, a format of the intermediate language data 402 is suitable for extraction and reuse with respect to the objects (objects such as a character, a line drawing, graphics, or a photograph) included in a page.

The metadata 401 holds data automatically generated in step S311 (FIG. 3). However, new information can also be added later to the metadata 401. The data held in the metadata 401 can be deleted (deregistered).

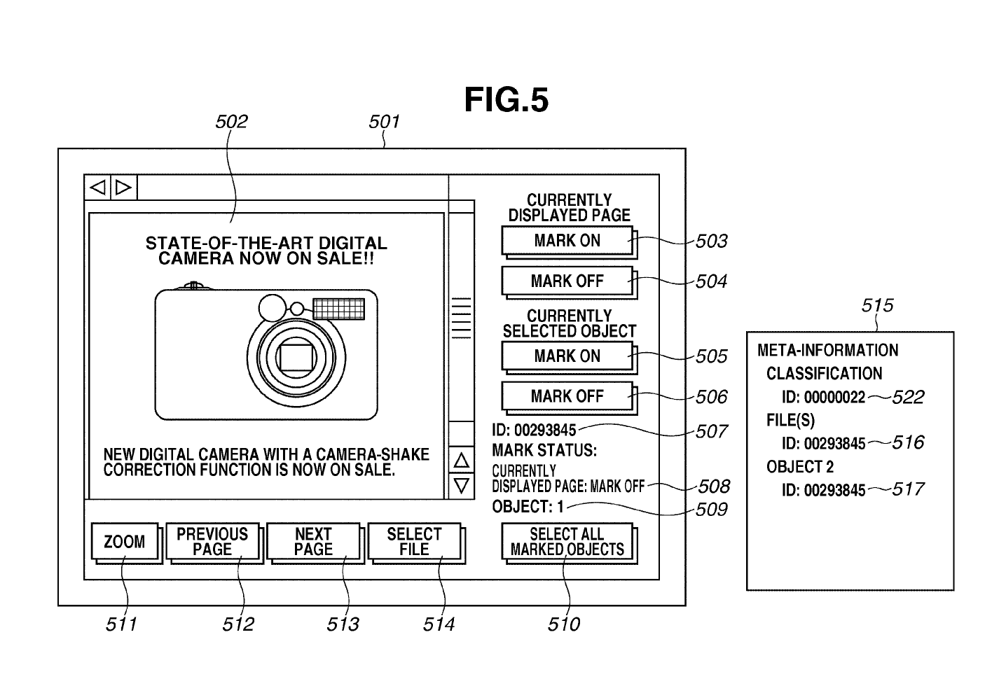

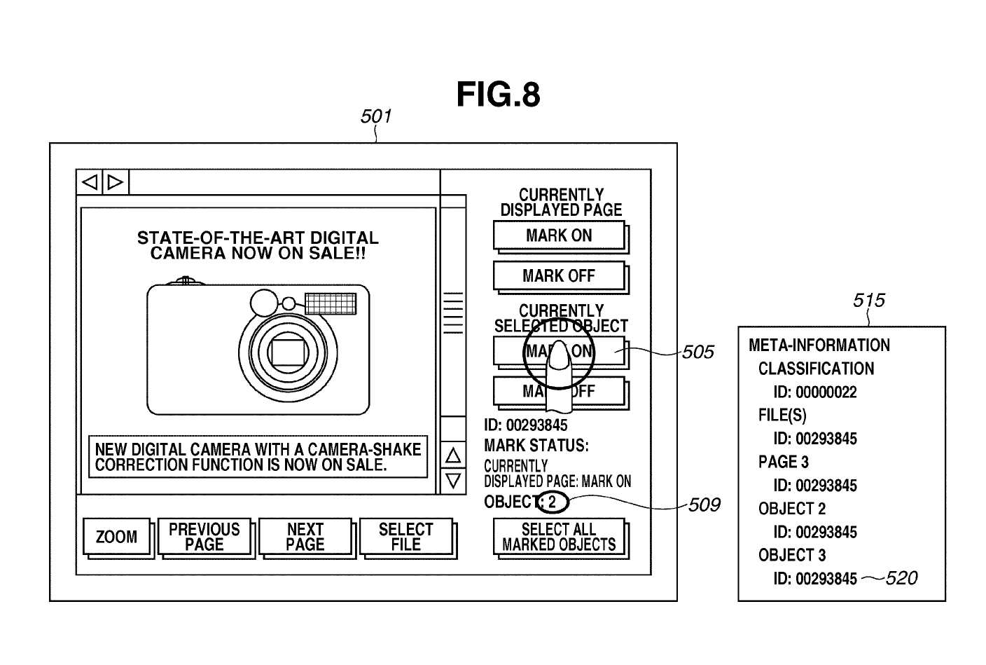

Now, operations for registering an ID (e. g., a user ID) in metadata as information and deregistering the registered ID via a GUI will be described in detail below with reference to FIGS. 5 through 10.

Referring to FIG. 5, an entire operation screen 501 includes a page display field 502, buttons 503 through 506, an ID display field 507, status display fields 508 and 509, and buttons 510 through 514.

Here, the button 503 is pressed by the user to issue an instruction for adding an ID to the metadata of a page (image data) displayed on the page display field 502. More specifically, the button 503 can be operated by the user to instruct “mark on”.

Further, the button 504 is pressed by the user to delete (deregister) the registered ID from the metadata of the page image data. More specifically, the button 504 can be operated by the user to instruct “mark off”.

The button 505 is a “mark on” button that is pressed by the user to issue an instruction for adding an ID to the object selected by the user in the displayed page image. The button 506 is a “mark off” button that is pressed by the user to deregister the registered identify from the object selected by the user.

The ID display field 507 displays a current ID (ID to be added to or deleted from the metadata).

The status display field 508 displays the status of marking on the currently displayed page, which indicates a status as to whether an ID has been added to the currently displayed page. Furthermore, the marking status display field 509 displays the status of marking on an object included in the currently displayed page, which indicates a status as to whether a marking has been added to the object included in the currently displayed page.

The “select all marked objects” button 510 is operated by the user to issue an instruction for selecting all marked objects included in the currently displayed page. The button 511 is a “zoom” button, which is operated by the user to issue an instruction for magnifying or reducing the currently displayed page.

The button 512 is a “previous page” button, which is operated by the user to issue an instruction for returning from the currently displayed page to a previously displayed page. The button 513 is a “next” button, which is operated by the user to issue an instruction for advancing from the currently displayed page to a subsequent page. The “select file” button 514 is operated by the user to re-select a different file.

Furthermore, in the example illustrated in FIG. 5, information embedded in the currently displayed page, namely, the content of meta-information 515, is indicated with a classification ID 522, which indicates a classification of the file itself, a file ID 516, and an object ID 517.

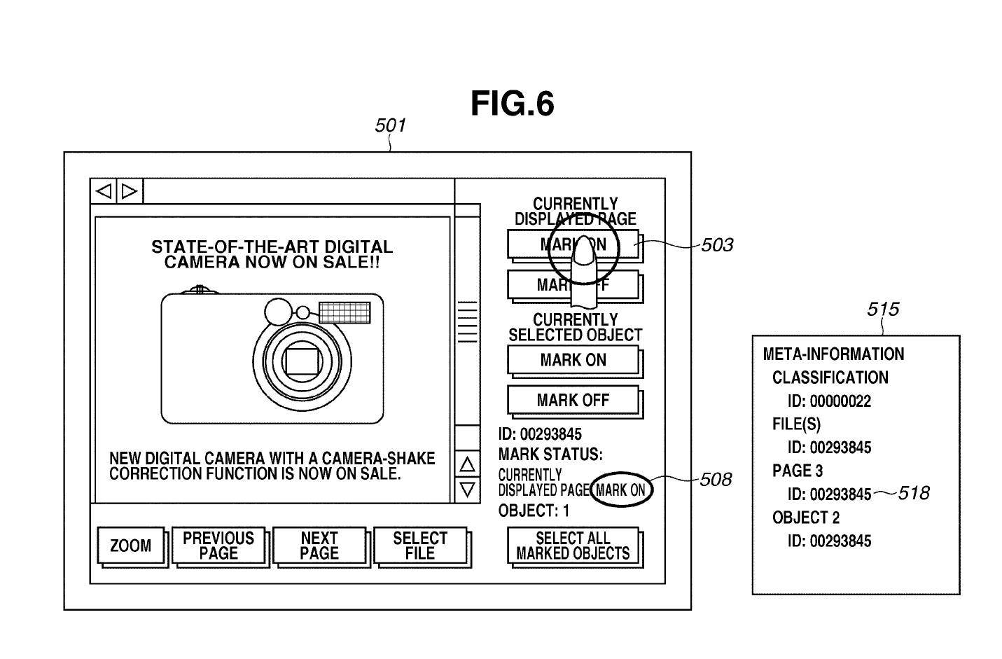

When the “mark on” button 503 is pressed on the operation screen 501 by the user with respect to the currently displayed page, a content of the display in the status display field 508 with respect to the currently displayed page changes from “mark off” (FIG. 5) to “mark on” (FIG. 6). At this time, an ID for the currently displayed page (“page 3”) is registered in the meta-information 515. An item “page 3” and its ID 518 are associated with each other and registered in the meta-information 515.

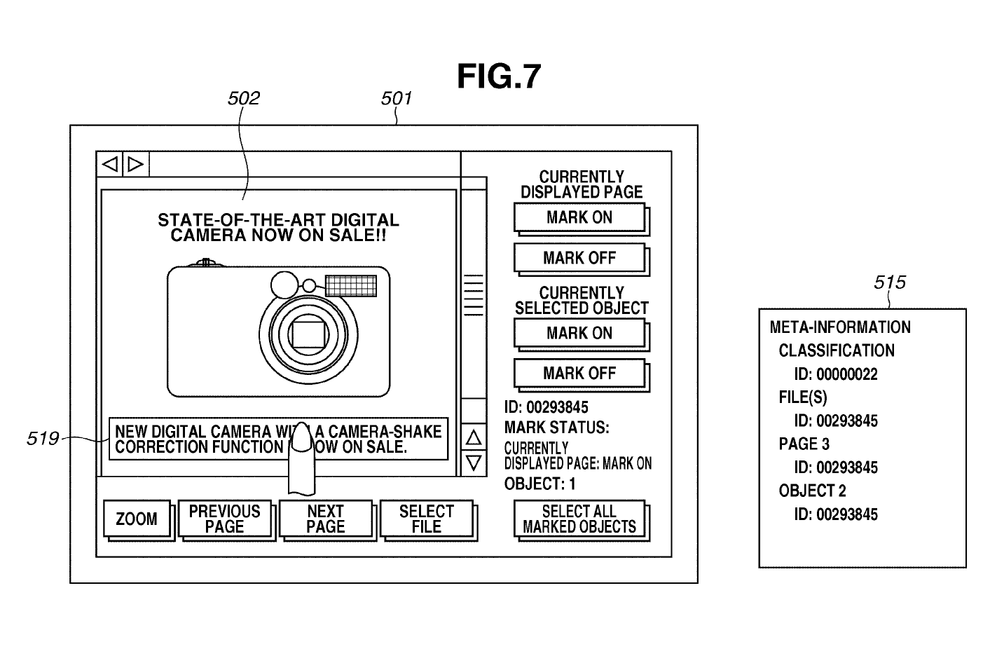

Further, when the user touches the screen at a portion of a character string 519 displayed in the page display field 502 (see FIG. 7), the character string 519 is highlighted by a frame to indicate that the character string 519 has been selected. At the time, if the user presses the “mark on” button 503 with respect to the currently selected object, then the value for the number of marked objects displayed in the “marking status” field is incremented by one to indicate that a new ID has been added. In this case, a third object “object 3” is added to the meta-information 515. An ID 520 is added thereto.

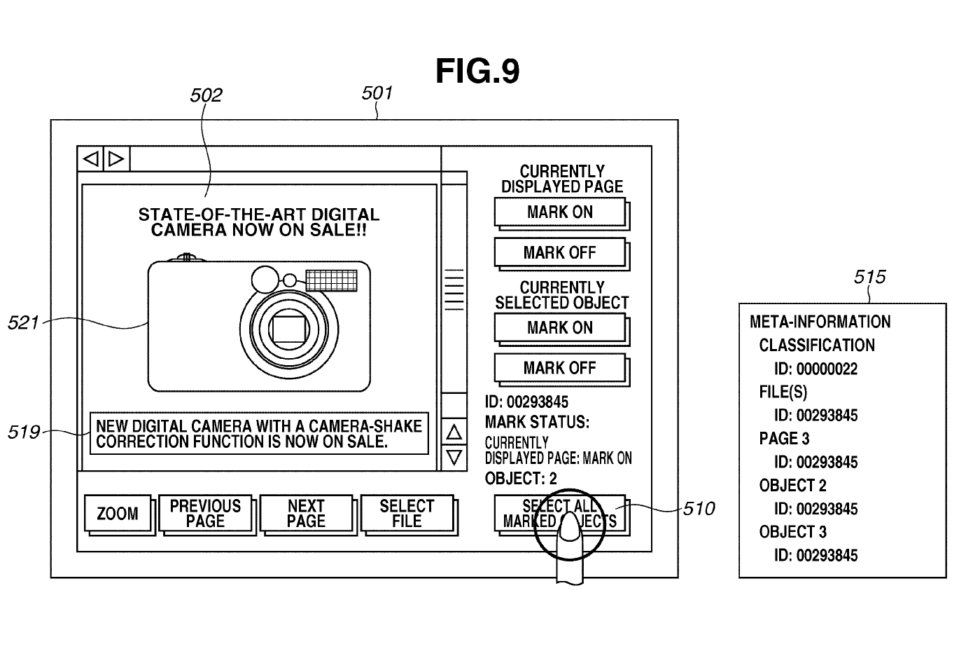

FIG. 9 illustrates an example of processing performed when the “select all marked objects” button 510 is pressed by the user to select all the objects to which an ID in the currently displayed page is added. In this case, objects 521 and 519, to which an ID in the page display field 502 has been added, are highlighted by a frame to indicate that they have been selected by the user.

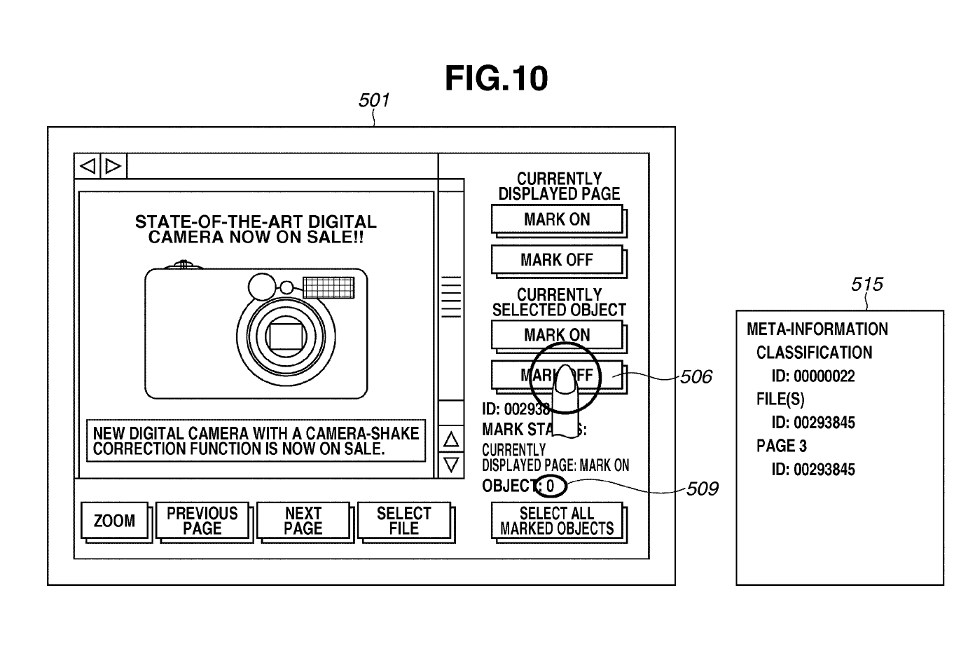

The user can press the “mark off” button 506 (FIG. 10) to delete an ID from all the objects. Then, a value “0” is displayed in the marking status display field 509 for the object in the currently displayed page, which indicates a status about whether an ID has been added to the object included in the currently displayed page. In addition, an ID for the object is deleted from the meta-information 515 for the currently displayed file.

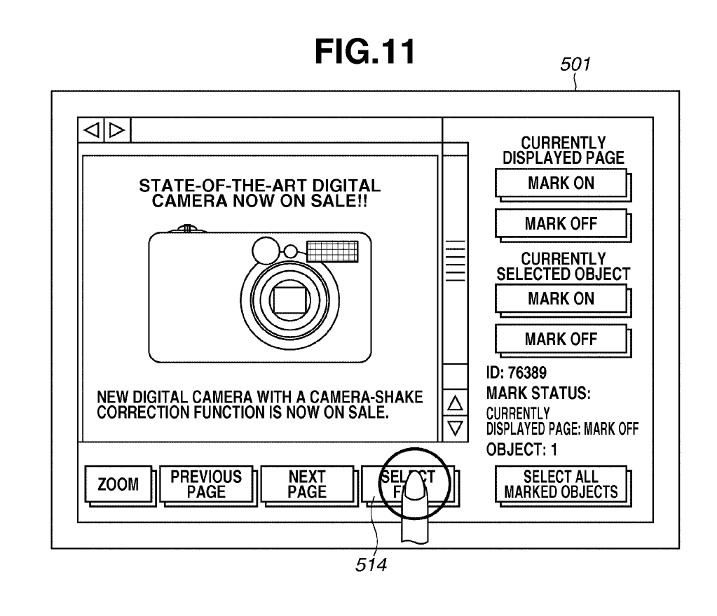

Now, an operation for registering classification IDs in metadata via the GUI of the system according to the present exemplary embodiment will be described in detail below with reference to FIGS. 11, 12, and 13.

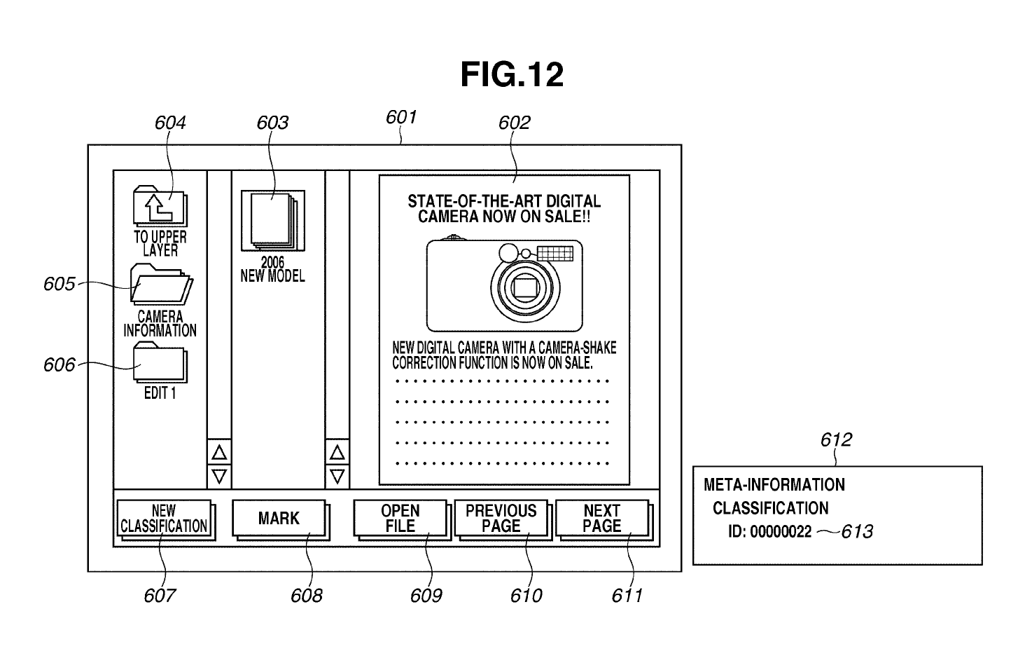

FIG. 11 illustrates an example of an operation screen for registering an ID in the page or the object. As illustrated in FIG. 11, when the user presses the “select file” button 514, the display advances to a data classification screen illustrated in FIG. 12.

Referring to FIG. 12, a data classification screen 601 includes a classification display field 604, a data selection field 603, a page preview field 602, and buttons 607 through 611.

The classification display field 604 displays a classification of a currently registered file. The page preview field 602 displays a preview of the content of the selected data.

Furthermore, the “next page” button 611 is operated by the user to issue an instruction for shifting the display of the page having the selected data as its content to a next page. The “previous page” button 610 is operated by the user to issue an instruction for sifting the currently displayed page to a previous page.

The “open file” button 609 is operated by the user to issue an instruction for shifting to the operation screen 501 via which the user registers an ID for a page and an object. The “mark on” button 608 is operated by the user to add a file itself. The “new classification” button 607 is operated by the user to issue an instruction for adding a new classification. The example in FIG. 12 illustrates a state in which classifications “camera information” 605 and “editing 1” 606 are registered.

Now, processing is described for registering an ID so that a file 603, which has been classified in the currently displayed classification “camera information” 605, can be also classified in the classification “edition 1”.

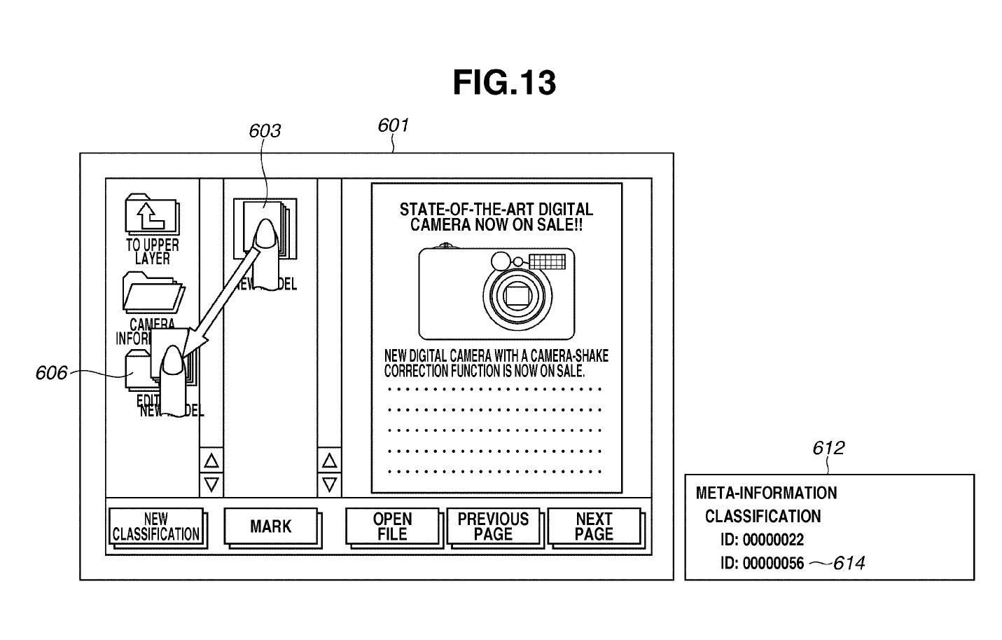

The currently selected file 603 belongs to a classification ID 613, as illustrated in a region 612 (FIG. 12). When the user drags the currently selected file 603 into the “edition 1” field 606, a new ID 614 is added to the classification IDs as illustrated in the region 612 (FIG. 13).

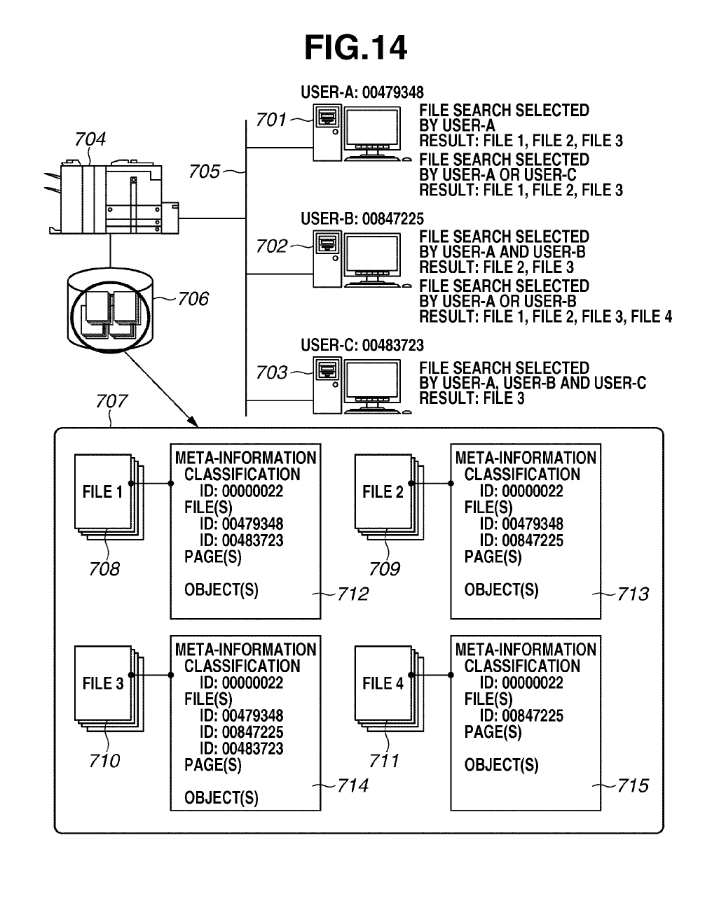

Now, a flow of processing for searching for a file using the ID that has been registered in the above-described manner will be described in detail below with reference to FIG. 14. In FIG. 14, client PCs 701-703 can access to an MFP 704 via a network 705. The MFP 704 can access the data storage system 706. The data storage system 706 stores files 708-711 and each meta-information 712-715 in a storage area 707.

When an instruction is given at a client PC 701 for starting a search for a file which has been selected by a “User-A”, the instruction for performing the search with the ID of the User-A is sent from the client PC 701 to an MFP 704 via a network 705. After receiving the instruction for the search, the MFP 704 accesses a data storage system 706 using the received ID.

Then, the MFP 704 performs a collation of the received ID and the registered ID included in the meta-information. Then, the MFP 704 sends, to the client PC 701, only information about a file corresponding to the meta-information that includes the registered ID which has been determined to match the received ID via the network 705. For example, in FIG. 14, the MFP 704 sends information of the files 1-3, each meta-information of the files 1-3 including the registered ID which matches the ID of the User-A.

In the case where a search is performed, at a client PC 702, for a file selected by both the User-A and a User-B, an instruction for performing an “AND” search using the ID of each of the User-A and the User-B is sent from the client PC 702 to the MFP 704 via the network 705. After receiving the instruction for performing the search, the MFP 704 accesses the data storage system 706, first using the received ID of the User-A.

Then, the MFP 704 collates the received ID of the User-A with the registered ID included in the meta-information for each data to determine if the IDs match each other. Further, the MFP 704 registers a name of the search target file in a data list. Then, the MFP 704 collates the received ID of the User-B and the meta-information based on the data list for their matching. The MFP 704 sends information about the file corresponding to the meta-information that includes the registered ID which has been determined to match the received ID of both the User-A and the User-B to the client PC 702 via the network 705. For example, in FIG. 14, the MFP 704 sends information of the files 2-3, each meta-information of the files 2-3 including the registered IDs which matches the IDs of both the User-A and the User-B.

Meanwhile, in the case where a search is performed, at the client PC 702, for all files selected by either of the User-A or the User-B, an instruction for performing an “OR” search using the IDs of the User-A and the User-B is sent from the client PC 702 to the MFP 704 via the network 705. After receiving the instruction for the search, the MFP 704 accesses the data storage system 706, first using the received ID of the User-A.

Then, the MFP 704 collates the received ID of the User-A with the registered ID included in the meta-information for each data to determine if the IDs match each other. Further, the MFP 704 registers a name of the search target file in a generated data list. Then, the MFP 704 accesses the data storage system 706, using the received ID of the User-B. The MFP 704 collates the received ID of the User-B with the registered ID included in the meta-information for each data to determine if the IDs match each other. If it is determined that the same file name as the file name of the search target file is not recorded in the generated data list, the MFP 704 records the file name of the search target file. After the search is completed, the MFP 704 returns the name of the files registered in the data list to the client PC 702. For example, in FIG. 14, the MFP 704 sends information of the files 1-4, each meta-information of the files 1-4 including the registered ID which matches the ID of either of the User-A or the User-B. Meanwhile, in the case where a search is performed, at a client PC 703, for a file selected by all of a User-A, a User-B and a User-C, an instruction for performing an “AND” search using the IDs of the User-A, the User-B and the User-C is sent from the client PC 703 to the MFP 704 via the network 705. Then the MFP 704 sends information of the files 3, wherein meta-information of the file 3 includes the registered IDs which matches the ID of all of the User-A, the User-B and the User-C.

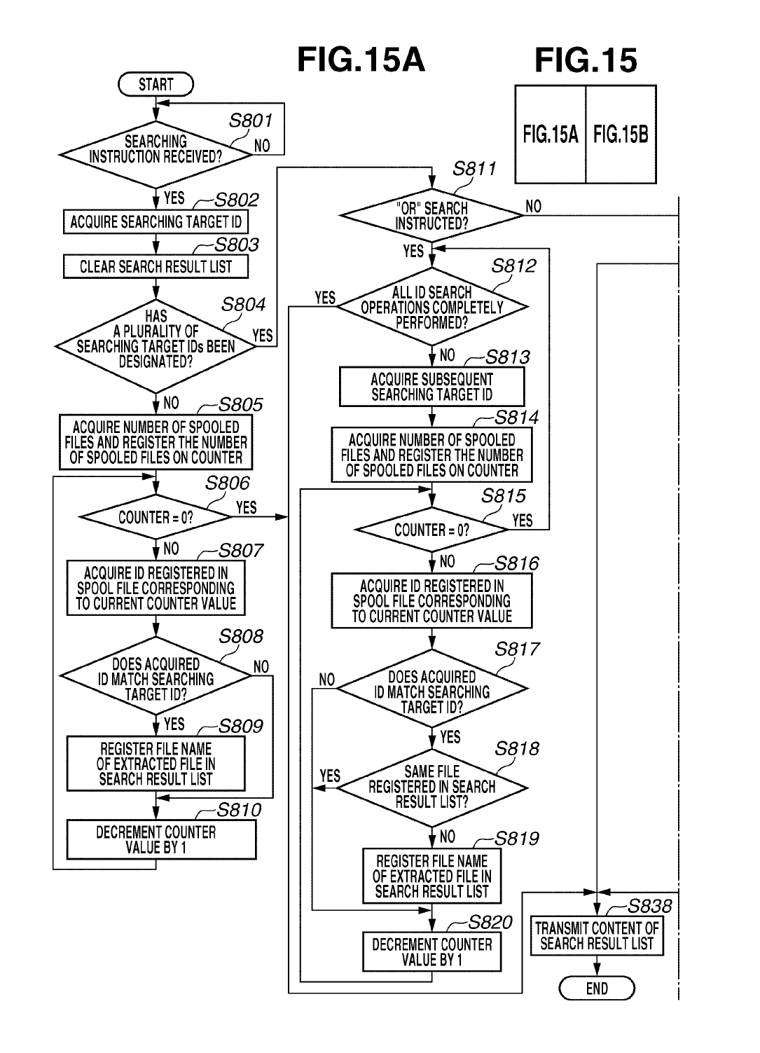

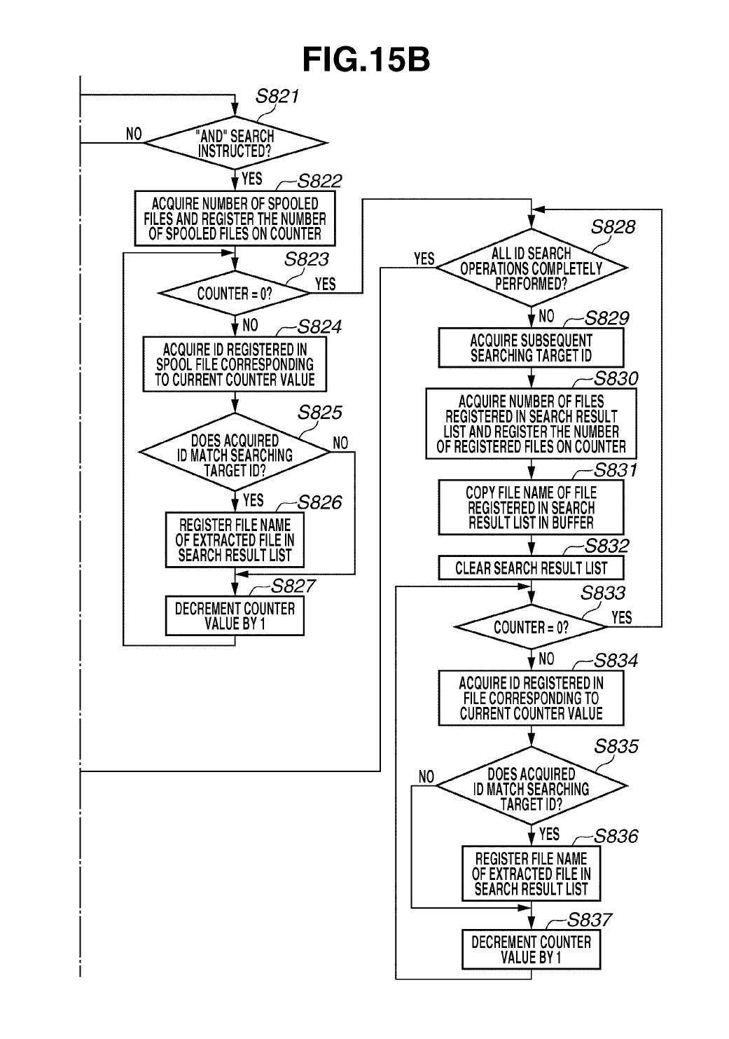

Now, an exemplary flow of processing for searching for a file will be described in detail below with reference to a flow chart of FIG. 15. The processing in each step illustrated in FIG. 15 is performed by the CPU (not illustrated) of the image forming apparatus illustrated in FIG. 1.

Referring to FIG. 15, in step S801, the CPU determines whether a search instruction has been received. If it is determined in step S801 that no search instruction has been received (NO in step S801), then the processing in step S801 is repeated until a search instruction is received.

On the other hand, if a search instruction has been received (YES in step S801), then the processing advances to step S802.

In step S802, the CPU acquires a searching target ID. Then, the processing advances to step S803. In step S803, the CPU clears the search result list. Then, the processing advances to step S804.

In step S804, the CPU determines whether a plurality of searching target IDs has been designated. If a plurality of searching target IDs has been designated (YES in step S804), then the processing advances to step S805.

In step S805, the CPU acquires the number of spooled files and registers the acquired number of spooled files in the counter. Then, the processing advances to step S806.

In step S806, the CPU determines whether the counter is set to “0”. If the counter is not set to “0” (NO in step S806), then the processing advances to step S807.

In step S807, the CPU acquires an ID registered in a spool file corresponding to a current counter value. Then, the processing advances to step S808.

In step S808, the CPU determines whether the searching target ID and the ID registered in the file match each other. If the searching target ID and the ID registered in the file match each other (YES in step S808), then the processing advances to step S809.

In step S809, the CPU registers file name in the search result list. Then, the processing advances to step S810.

On the other hand, if it is determined in step S808 that the searching target ID and the ID registered in the file do not match each other (NO in step S808), then the processing advances to step S810.

In step S810, the CPU decrements the counter by 1. Then, the processing advances to step S806 and repeats the above-described processing.

On the other hand, if it is determined in step S806 that the counter is set to “0” (YES in step S806), then the processing advances to step S838.

On the other hand, if it is determined in step S804 that a plurality of searching target IDs has been designated (YES in step S804), then the processing advances to step S811.

In step S811, the CPU determines whether an “OR” search has been instructed by the user. If an “OR” search has been instructed by the user (YES in step S811), then the processing advances to step S812.

In step S812, the CPU determines whether all ID search operations have been completely performed. If all ID search operations have not been completely performed yet (NO in step S812), then the processing advances to step S813.

In step S813, the CPU acquires a next searching target ID. Then, the processing advances to step S814.

In step S814, the CPU acquires the number of spooled files and registers the acquired number of spooled files in the counter. Then, the processing advances to step S815.

In step S815, the CPU determines whether the counter is set to “0”. If the counter is not set to “0” (NO in step S815), then the processing advances to step S816.

In step S816, the CPU acquires an ID registered in a spool file corresponding to a current counter value. Then, the processing advances to step S817.

In step S817, the CPU determines whether the searching target ID and the ID registered in the file match each other. If the searching target ID and the ID registered in the file match each other (YES in step S817), then the processing advances to step S818.

In step S818, the CPU determines whether the same file is registered in the search result list. If the same file is not registered in the search result list (NO in step S818), then the processing advances to step S819.

In step S819, the CPU registers the file name in the search result list. Then, the processing advances to step S820.

On the other hand, if it is determined in step S818 that the same file is registered in the search result list (YES in step S818), then the processing advances to step S820.

If it is determined in step S817 that the searching target ID and the ID registered in the file do not match each other (NO in step S817), then the processing advances to step S820.

In step S820, the CPU decrements the counter by 1. Then, the processing returns to step S815 and the above-described processing is repeated.

On the other hand, if it is determined in step S815 that the counter is set to “0” (YES in step S815), then the processing advances to step S812.

If it is determined in step S812 that all ID search operations have been completely performed (YES in step S812), then the processing advances to step S838.

If it is determined in step S811 that no “OR” search has been instructed by the user (NO in step S811), then the processing advances to step S821.

In step S821, the CPU determines whether an “AND” search has been instructed. If an “AND” search has been instructed (YES in step S821), then the processing advances to step S822.

In step S822, the CPU acquires the number of spooled files and registers the acquired number of spooled files in the counter. Then, the processing advances to step S823.

In step S823, the CPU determines whether the counter is set to “0”. If the counter is not set to “0” (NO in step S823), then the processing advances to step S824.

In step S824, the CPU acquires an ID registered in a spool file corresponding to a current counter value. Then, the processing advances to step S825.

In step S825, the CPU determines whether the searching target ID and the ID registered in the file match each other. If the searching target ID and the ID registered in the file match each other (YES in step S825), then the processing advances to step S826.

In step S826, the CPU registers a file name in the search result list. Then, the processing advances to step S827.

On the other hand, if it is determined in step S825 that the searching target ID and the ID registered in the file do not match each other (NO in step S825), then the processing advances to step S827.

In step S827, the CPU decrements the counter by 1. Then, the processing returns to step S821 and the above-described processing is repeated.

On the other hand, if it is determined in step S823 that the counter is set to “0” (YES in step S823), then the processing advances to step S828.

In step S828, the CPU determines whether the search has been finished for all IDs included in the received search instruction. If the search has not been finished for all IDs included in the received search instruction (NO in step S828), then the processing advances to step S829.

In step S829, the CPU acquires a subsequent searching target ID. Then, the processing advances to step S830.

In step S830, the CPU acquires the number of files registered in the search result list and registers the acquired number of files registered in the search result list in the counter. Then, the processing advances to step S831.

In step S831, the CPU copies the file name registered in the search result list in the buffer. Then, the processing advances to step S832.

In step S832, the CPU clears the search result list. Then, the processing advances to step S833.

In step S833, the CPU determines whether the counter is set to “0”. If the counter is not set to “0” (NO in step S833), then the processing advances to step S834.

In step S834, the CPU acquires an ID registered in a file corresponding to a current counter value. Then, the processing advances to step S835.

In step S835, the CPU determines whether the searching target ID and the ID registered in the file match each other. If the searching target ID and the ID registered in the file match each other (YES in step S835), then the processing advances to step S836.

In step S836, the CPU registers the file name of a file corresponding to the current counter value in the search result list. Then, the processing advances to step S837.

On the other hand, if it is determined in step S835 that the searching target ID and the ID registered in the file do not match each other (NO in step S835), then the processing advances to step S837.

In step S837, the CPU decrements the counter by 1. Then, the processing returns to step S833 and the above-described processing is repeated.

On the other hand, if it is determined in step S833 that the counter is set to “0” (YES in step S833), then the processing returns to step S828 and the above-described processing is repeated.

If it is determined in step S828 that the search operation has been completely performed for all IDs included in the received search instruction (YES in step S828), then the processing advances to step S838.

In step S838, the CPU sends the search result list. Then, the processing ends.

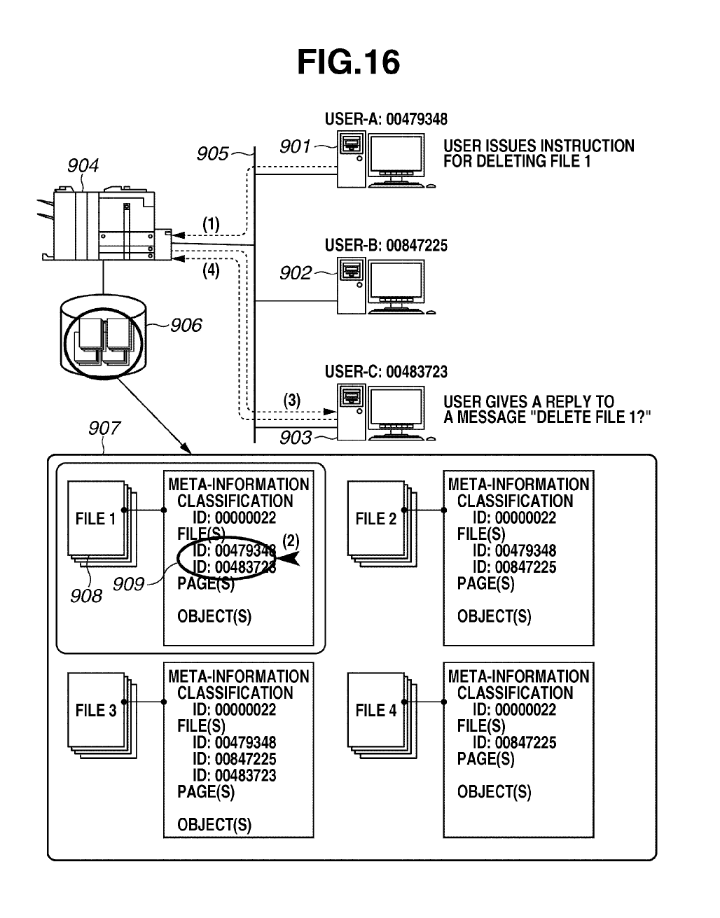

Now, the processing for deleting a file spooled in the data storage system is described in detail below with reference to FIG. 16. In FIG. 16, client PCs 901-903 can access to an MFP 904 via a network 905. The MFP 904 can access the data storage system 906. The data storage system 906 stores the files 1-4 and each meta-information in a storage area 907. Referring to FIG. 16, when the User-A issues an instruction for deleting a File 1 from a client PC 901, the instruction is notified to an MFP 904 via a network 905.

Upon receiving the instruction for deleting the File 1, the MFP 904 reads the File 1 (the deletion target file) 908 from a data storage system 906. Then, the MFP 904 refers to meta-information included in the File 1 908 and acquires IDs 909 registered in meta-information of the File 1 908.

Then, the MFP 904 sends an inquiry to a User-C via the network 905 to inquire the User-C, whose ID is still registered in the File 1, whether the File 1 can be deleted. When the User-C accesses the network 905 from a client PC 903, the inquiry about whether the File 1 can be deleted reaches the client PC 903 and the User-C responds to the inquiry. In the case where the User-C permits the deletion of the File 1, the permission of deletion of File 1 is sent to the MFP 904 via the network 905. Upon receiving the deletion permission notification, the MFP 904 deletes the ID for the User-C from the File 1 908.

Then, the MFP 904 detects whether any other ID is registered in the File 1 908. If it is determined that no other ID is registered, then the MFP 904 deletes the File 1 908.

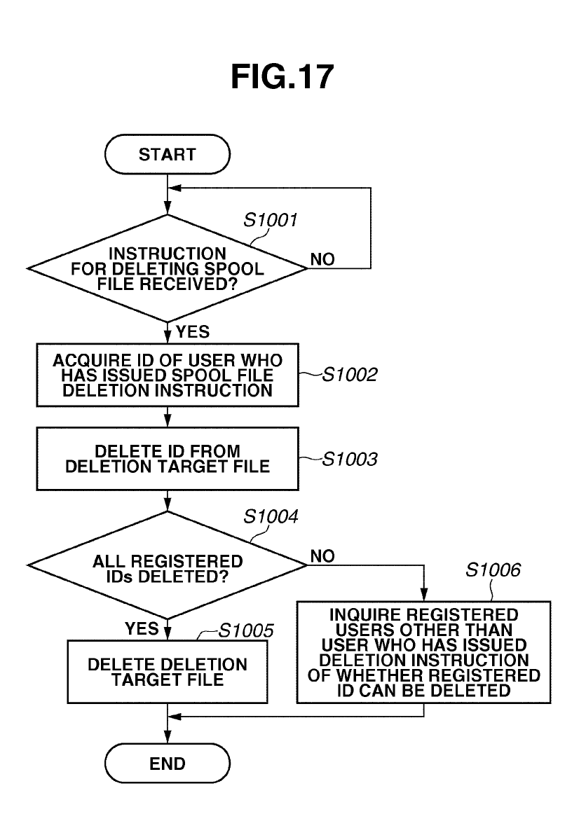

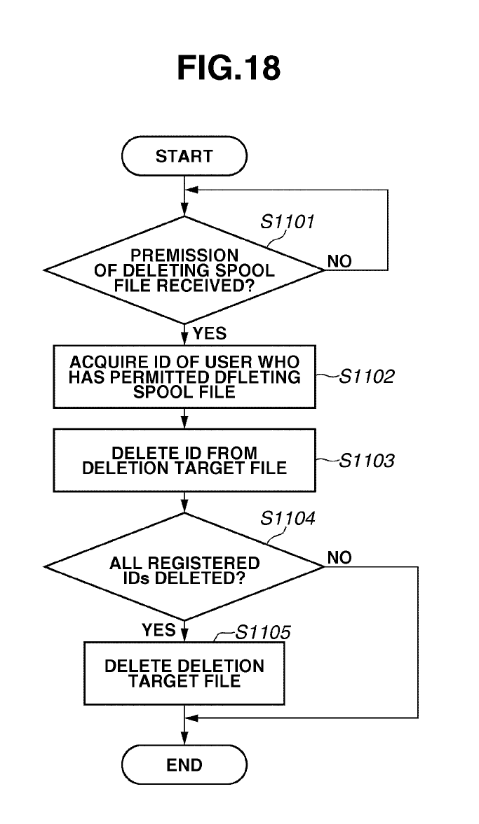

Processing performed by the MFP for deleting the file spooled in the data storage system 906 is described in detail below with reference to flow charts illustrated in FIGS. 17 and 18. The processing in each step illustrated in FIG. 17 to be described below is performed by the CPU (not illustrated) of the image forming apparatus illustrated in FIG. 1.

Referring to FIG. 17, in step S1001, the CPU determines whether a spool file deletion instruction has been received. If no instruction for spool file deletion has been received (NO in step S1001), then the processing in step S1001 is repeated until the instruction for a spool file deletion is received.

On the other hand, if it is determined in step S1001 that a spool file deletion instruction has been received (YES in step S1001), then the processing advances to step S1002.

In step S1002, the CPU acquires the ID for the user who has issued the instruction for spool file deletion. Then, the processing advances to step S1003.

In step S1003, the CPU deletes the ID from the deletion target file. Then, the processing advances to step S1004.

In step S1004, the CPU determines whether all the registered IDs have been deleted from the deletion target file. If all the registered IDs have been deleted from the deletion target file (YES in step S1004), then the processing advances to step S1005.

In step S1005, the CPU deletes the deletion target file. Then, the processing ends.

On the other hand, if it is determined in step S1004 that all the registered IDs have not been deleted from the deletion target file (NO in step S1004), then the processing advances to step S1006.

In step S1006, the CPU inquires the user who has issued the deletion instruction whether his ID can be deleted from the file. Then, the processing ends.

Now, processing for deleting the user ID from the deletion target file illustrated in FIG. 18 is described. The processing in each step illustrated in FIG. 18 is performed by the CPU (not illustrated) of the image forming apparatus illustrated in FIG. 1.

Referring to FIG. 18, in step S1101, the CPU determines whether a spool file deletion permission has been received. If no spool file deletion permission has been received (NO in step S1101), then the processing in step S1101 is repeated until a spool file deletion permission is received.

On the other hand, if it is determined in step S1101 that a spool file deletion permission has been received (YES in step S1101), then the processing advances to step S1102.

In step S1102, the CPU acquires the ID for the user who has issued the spool file deletion permission. Then, the processing advances to step S1103.

In step S1103, the CPU deletes the ID from the deletion target file. Then, the processing advances to step S1104.

In step S1104, the CPU determines whether all registered IDs have been deleted from the deletion target file. If all registered IDs have been deleted from the deletion target file (YES in step S1104), then the processing advances to step S1105.

In step S1105, the CPU deletes the deletion target file. Then, the processing ends.

On the other hand, if it is determined in step S1104 that all registered IDs have not been deleted (NO in step S1004), then the processing ends.

### Second Exemplary Embodiment

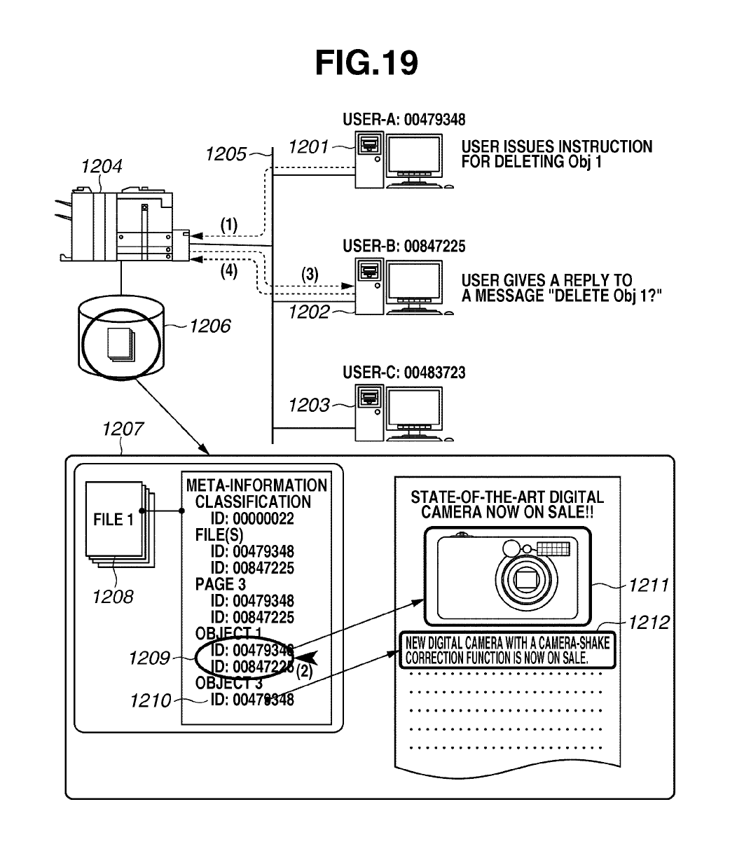

A second exemplary embodiment of the present invention is described below. Here, processing for deleting an object included in spool data will be described in detail below with reference to FIGS. 19 through 22. For example, in FIG. 19, client PCs 1201-1203 can access to an MFP 1204 via a network 1205. The MFP 1204 can access the data storage system 1206. The data storage system 1206 stores file 1208 and each meta-information in a storage area 1207.

Referring to FIG. 19, when the User-A issues an instruction from a client PC 1201 for deleting an object 1211 included in a File 1 1208, which is spooled in a data storage system 1206 of an MFP 1204, the processing is performed in the following manner.

That is, first, the User-A sends the deletion instruction from the client PC 1201 to the MFP 1204 via a network 1205. Upon receiving the deletion instruction, the MFP 1204 searches for the File 1 1208, which is spool data including the object 1211, from the data storage system 1206 installed in the MFP 1204 and reads the extracted File 1 1208.

Then, the MFP 1204 extracts an ID 1209 assigned to the object 1211 included in the File 1 1208. If only the ID for the User-A who has issued the deletion instruction has been assigned, then the MFP 1204 deletes the object 1211. In the example illustrated in FIG. 19, an ID 1210 also is assigned to an object 1212.

On the other hand, if it is determined that the ID 1209 assigned to the object 1211 exists also for a user other than the User-A who has issued the deletion instruction, then the MFP 1204 issues a deletion permission request to another user whose ID has been registered in the object 1211, via the network 1205. When another User-B, whose ID has been registered in the object 1211, accesses the network 1205 from a client PC 1202, the User-B receives the deletion permission request.

At this time, the following processing is performed on the data. The File 1 1208 is copied and spooled in the data storage system 1206. Then, all IDs for the User-A are deleted from a copy source file. Then, the IDs for all the users other than the User-A are deleted from a copy destination file.

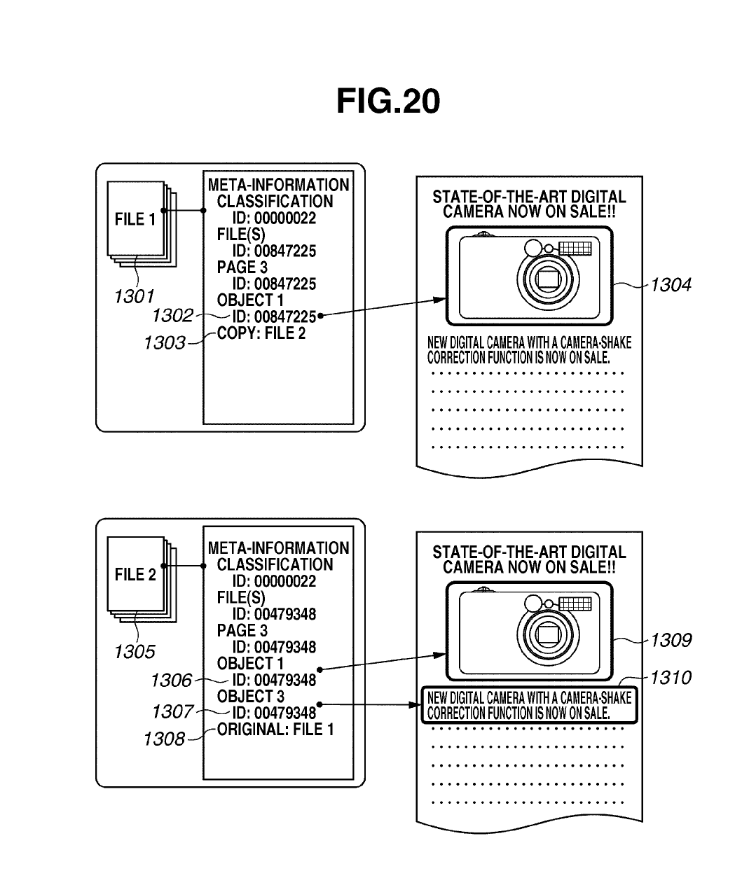

As a result, as illustrated in FIG. 20, the file is segmented into a File 1 1301, which is a copy source, and a File 2 1305, which is a copy destination. Furthermore, a copy destination file name 1303 is added to the File 1 1301 as copy information to clearly indicate the copy destination.

Here, an ID 1302 is assigned to an object 1304. Furthermore, a copy source file name 1308 is added to the File 2 1305 as copy source information to clearly indicate a copy source. In addition, a history of change from the copy source is registered in the File 2 1305.

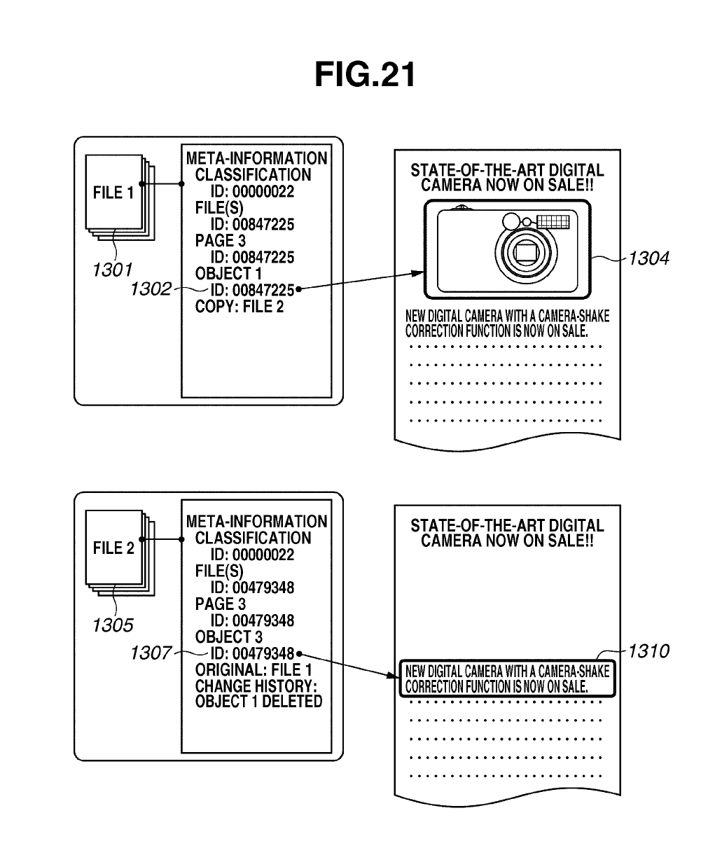

Then, an object 1309 included in the File 2 1305, which the User-A has designated as a deletion target is deleted. Furthermore, an ID 1306, which is assigned to the object 1309, is deleted (FIG. 21). Here, an ID 1307 is assigned to an object 1310.

If the User-B has not permitted the deletion of the object 1304, then the spool data is not processed here.

On the other hand, if the User-B has permitted the deletion of the object 1304, then the object deletion processing is verified as to whether it is included and appropriately recorded in the File 2 change history. If the object deletion processing is included in the File 2 change history, then all the IDs for the User-B registered in the File 1 1301 is added to the File 2 1305.

If no ID exists after verification with respect to the IDs registered in the File 1 1301, then the File 1 1301 is deleted and the history of change from the File 1 1301 recorded in the File 2 1305 is deleted. On the other hand, if it is determined that any other ID exists in the File 1 1301, the existing other ID is not processed here.

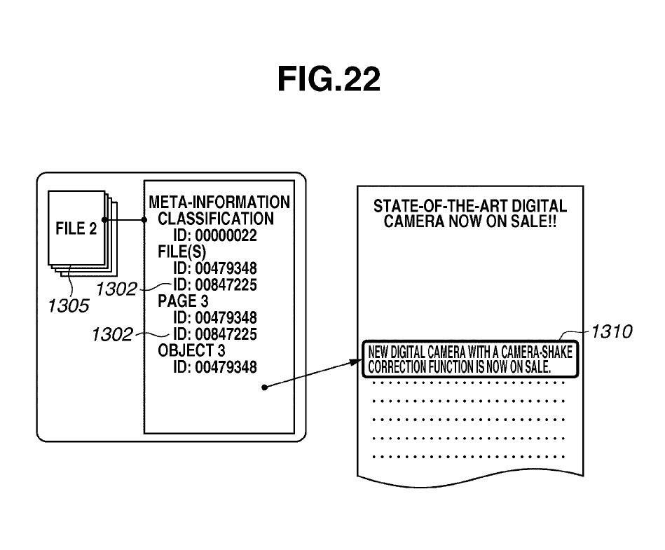

In the example illustrated in FIG. 22, the ID 1302 is added to the file and the “page 3”.

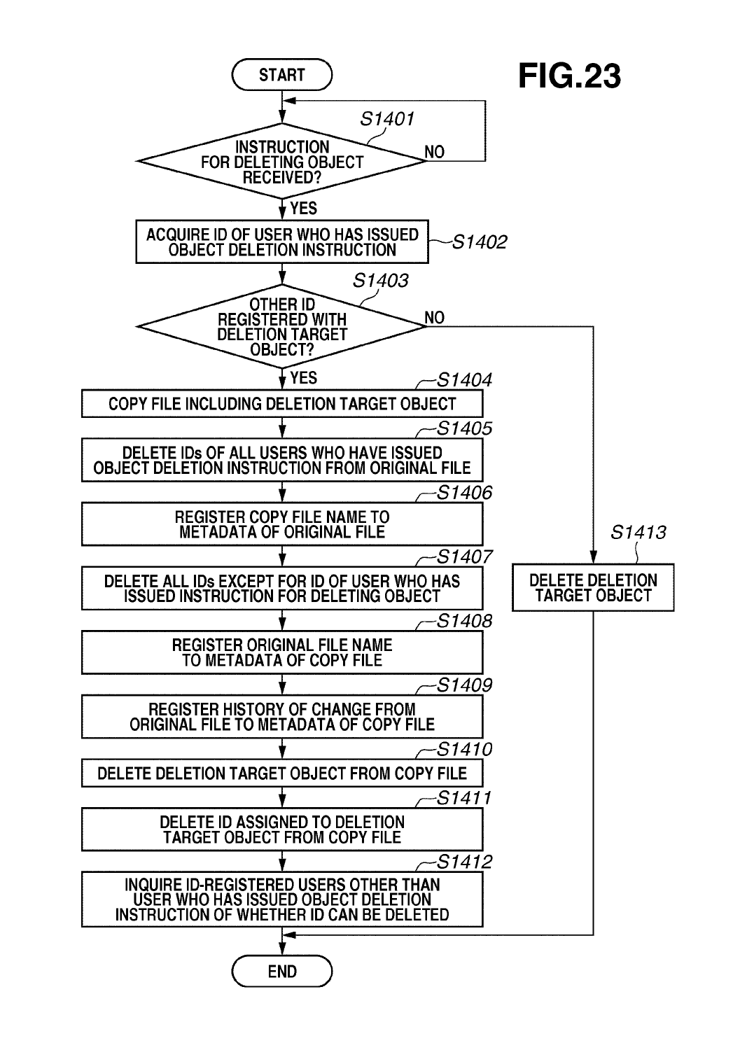

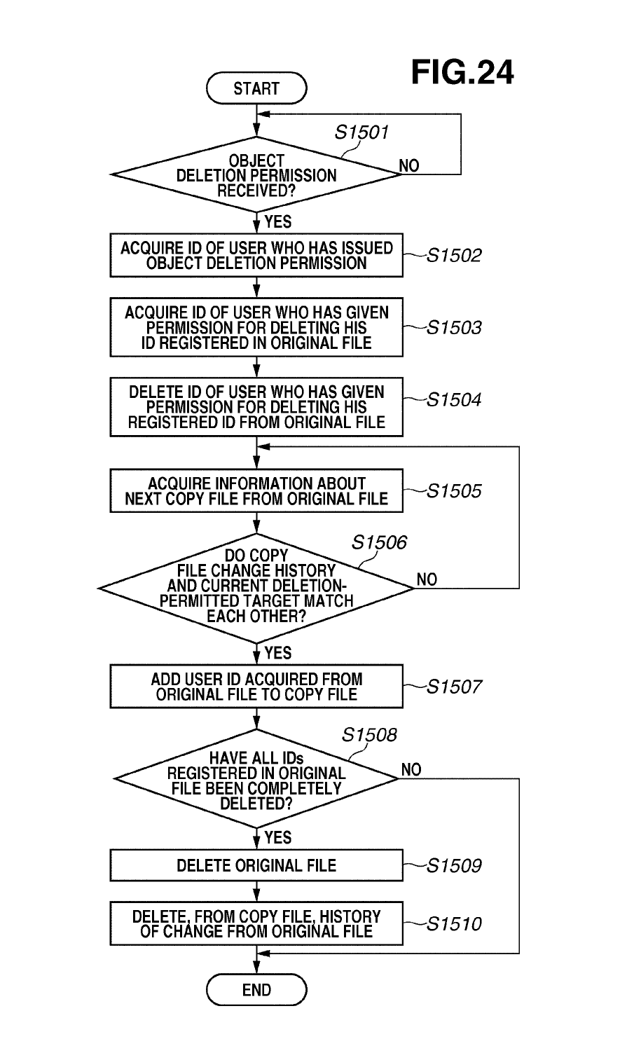

Processing performed by the MFP for deleting an object included in the spool file is described in detail below with reference to flow charts illustrated in FIGS. 23 and 24. To begin with, processing for issuing a deletion permission request based on a deletion instruction received from the user is described with reference to FIG. 23. Processing in each step illustrated in FIG. 23 is performed with the CPU (not illustrated) of the image forming apparatus illustrated in FIG. 1.

Referring to FIG. 23, in step S1401, the CPU determines whether an object deletion instruction has been received. If it is determined in step S1401 that no object deletion instruction has been received (NO in step S1401), then the processing in step S1401 is repeated until an object deletion instruction is received.

On the other hand, if it is determined in step S1401 that an object deletion instruction has been received (YES in step S1401), then the processing advances to step S1402.

In step S1402, the CPU acquires the ID for the user who has issued the object deletion instruction. Then, the processing advances to step S1403.

In step S1403, the CPU determines whether any other ID is registered in the deletion target object. If no other ID has been registered in the deletion target object (NO in step S1403), then the processing advances to step S1413.

In step S1413, the CPU deletes the deletion target object. Then, the processing ends.

On the other hand, if it is determined in step S1403 that another ID has been registered in the object (YES in step S1403), then the processing advances to step S1404.

In step S1404, the CPU copies the file including the deletion target object. Then, the processing advances to step S1405.

In step S1405, the CPU deletes all IDs for the user who has issued the object deletion instruction from the original file. Then, the processing advances to step S1406.

In step S1406, the CPU registers the copy file name in the metadata of the original file. Then, the processing advances to step S1407.

In step S1407, the CPU deletes the IDs for all the users other than the ID for the user who has issued the object deletion instruction from the copy file. Then, the processing advances to step S1408.

In step S1408, the CPU registers the original file name in the metadata of the copy file. Then, the processing advances to step S1409.

In step S1409, the CPU registers the history of change from the original file in the metadata of the copy file. Then, the processing advances to step S1410.

In step S1410, the CPU deletes the deletion target object from the copy file. Then, the processing advances to step S1411.

In step S1411, the CPU deletes the ID assigned to the deletion target object from the copy file. Then, the processing advances to step S1412.

In step S1412, the CPU issues a deletion permission request to the users whose ID has been registered other than the user who has issued the deletion instruction. Then, the processing ends.

Now, processing to be performed after the MFP has received a deletion permission/inhibition notification issued by the user in reply to the previously sent deletion permission request will be described in detail below with reference to FIG. 24. Processing in each step illustrated in FIG. 24 is performed by the CPU (not illustrated) of the image forming apparatus illustrated in FIG. 1.

Referring to FIG. 24, in step S1501, the CPU determines whether an object deletion permission notification has been received. If no object deletion permission notification has been received (NO in step S1501), then the processing in step S1501 is repeated until an object deletion permission notification is received.

On the other hand, if it is determined in step S1501 that an object deletion permission notification has been received (YES in step S1501), then the processing advances to step S1502.

In step S1502, the CPU acquires the ID for the user who has issued the deletion permission. Then, the processing advances to step S1503.

In step S1503, the CPU acquires the ID for the user who has issued the permission for deleting the ID registered in the original file. Then, the processing advances to step S1504.

In step S1504, the CPU deletes the registered user ID from the original file. Then, the processing advances to step S1505.

In step S1505, the CPU acquires subsequent copy file information from the original file. Then, the processing advances to step S1506.

In step S1506, the CPU determines whether the description in the copy file change history and the current deletion-permitted deletion target file match each other. If the description in the copy file change history and the current deletion-permitted deletion target file do not match each other (NO in step S1506), then the processing returns to step S1505 to repeat the above-described processing.

On the other hand, if it is determined in step S1506 that the description in the copy file change history and the current deletion-permitted deletion target file match each other (YES in step S1506), then the processing advances to step S1507.

In step S1507, the CPU adds a user ID acquired from the original file to the copy file. Then, the processing advances to step S1508.

In step S1508, the CPU determines whether all IDs registered in the original file have been deleted. If any ID registered in the original file still exists (NO in step S1508), then the processing ends.

On the other hand, if it is determined in step S1508 that all IDs registered in the original file have been deleted (YES in step S1508), then the processing advances to step S1509.

In step S1509, the CPU deletes the original file. Then, the processing advances to step S1510.

In step S1510, the CPU deletes the history of change from the original file registered in the copy file. Then, the processing ends.

### Other Exemplary Embodiments

In the above-described embodiments of the present invention, the MFP 104 includes the components described above with reference to FIG. 2. Namely, the MFP 104 includes the page description language analysis unit 204, the object analysis unit 205, the scanner 206, the region segmentation unit 207, the image analysis unit 208, the vectorization unit 209, the character analysis unit 210, the object information generation unit 211, the intermediate language generation unit 212, and the data storage system 213. In the above-described exemplary embodiment, the CPU (computer) of the MFP 104 executes a computer program stored on a computer-readable storage medium so that the CPU functions as one part of the above-described components of the MFP 104.

In the above-described exemplary embodiment of the present invention, some of the components thereof can be implemented by software. However, the present invention is not limited to this exemplary embodiment. That is, the components can be implemented by hardware such as an electronic circuit.

According to the above-described exemplary embodiments, a user ID can be easily assigned to image data or an object. Furthermore, since the IDs are registered in metadata, it is easy to manage the IDs.

Since the IDs are registered in the metadata, it is not necessary to restructure or regenerate a database even in the case where a search cannot be performed due to broken database or broken or moved file, unlike a conventional method in which the IDs are registered in a database. In addition, according to the present exemplary embodiment, if search target data is broken, the broken data is automatically excluded from search target data. Accordingly, it is not necessary to restructure the search target data.

In addition, according to the present exemplary embodiment, a search can be performed also as to an object included in a page as a search target. Furthermore, according to the present exemplary embodiment, a user can freely select an ID and assign the selected ID. Thus, the individual user can set desired and necessary information.

Moreover, in the present exemplary embodiment, the user can search a file, page, or an object using a designated ID. Accordingly, the user can search the file, page, or object selected by any other users.

Further, as described above, the present exemplary embodiment enables the user to perform a search based on a plurality of IDs. Thus, the user can perform a search over an enlarged or restricted scope.

In addition, the present exemplary embodiment enables the user to perform a “logical OR” search using a plurality of IDs. Thus, it is possible that a plurality of users search the files, pages, or objects shared and selected by the users.

In addition, the present exemplary embodiment enables the user to perform an “AND” search using a plurality of IDs. Thus, the user can perform a search of the files, pages, or objects selected by all users.

Furthermore, according to the present exemplary embodiment, it is possible that the operator can change a search mode between a “logical OR” search and an “AND” search of a plurality of IDs. Thus, the present exemplary embodiment can improve the efficiency of the search by the user.

In the present exemplary embodiment, in deleting an object included in a page, a request for permission of deleting the deletion target object is issued to all registered users based on the IDs registered in the files, pages, or objects. Accordingly, the file, page, or object is deleted only when all the registered users permit the deletion. Thus, according to the present exemplary embodiment, the case can be prevented where the user cannot refer to an ID previously selected and registered by the user.

Further, if all the users whose ID has been registered permits the requested deletion, the present exemplary embodiment deletes the deletion target file, page, or object. Accordingly, the present exemplary embodiment can save the recording capacity of a recording device of the apparatus by refraining from increasing the number of files, pages, or objects at every editing occasion.

Furthermore, if at least one ID-registered user does not permit the requested deletion, the present exemplary embodiment does not delete the file including data having the common format, the page including the data having the common format, or the object included in the page having the common-format data. Accordingly, the case can be prevented where the user cannot refer to the previously selected and registered ID.

According to the present exemplary embodiment, the operator can search a file, page, or object including the same ID as the designated ID based on the ID embedded in the common-format data.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2007-207155 filed Aug. 8, 2007, which is hereby incorporated by reference herein in its entirety.

What is claimed is:

1. An image processing apparatus comprising:
a segmentation unit configured to segment input image data into a plurality of objects;
a generation unit configured to generate data having a format including the image data and metadata for the image data; and
a registration unit configured to register, in the metadata, an identifier for a user with respect to at least one of the image data and the object based on a user instruction.

2. The image processing apparatus according to claim 1, wherein
the registration unit is configured to cause to be displayed a graphical user interface, which includes at least a region for displaying the image data, a button for registering the identifier to the image data, and a button for registering the identifier to the object, and
wherein the registration unit, based on an instruction issued by a user via the displayed graphical user interface, is configured to register in the metadata the identifier for the user with respect to at least one of the image data and the object.

3. The image processing apparatus according to claim 1, further comprising a searching unit configured to search for image data or an object including a same identifier as an identifier designated by an operator based on the identifier registered in the data having the format.

4. The image processing apparatus according to claim 3, wherein the searching unit is configured to perform a search using a plurality of identifiers.

5. The image processing apparatus according to claim 4, wherein the searching unit is configured to perform a logical OR search using the plurality of identifiers.

6. The image processing apparatus according to claim 4, wherein the searching unit is configured to perform an AND search using the plurality of identifiers.

7. The image processing apparatus according to claim 4, wherein the searching unit performs a logical OR search or an AND search that use the plurality of identifiers based on a user's selection of a search mode.

8. The image processing apparatus according to claim 1, further comprising a notification unit configured, based on the identifier registered for the image data or the object, to send a notification to the user having the registered identifier, the notification comprising a request for a permission for deleting the image data or the object.

9. The image processing apparatus according to claim 8, further comprising a deletion unit configured to delete the image data or the object which the user has instructed to delete if the request is permitted by the user.

10. The image processing apparatus according to claim 9, wherein the deletion unit does not delete the image data or the object which the user has instructed to delete if the request is not permitted.

11. The image processing apparatus according to claim 1, wherein if the image data is scanned data, then the segmentation unit performs a region segmentation on the image data to segment the image data into a plurality of objects based on an attribute thereof, while if the image data is page description language data, then the segmentation unit performs a language analysis to segment the page description language data into a plurality of objects based on an attribute thereof.

12. The image processing apparatus according to claim 1, wherein the registration unit registers in the metadata a keyword which has been extracted from the object.

13. The image processing apparatus according to claim 1, wherein the image data included in data generated by the generation unit is described in an intermediate language.

14. A method comprising:
segmenting input image data into a plurality of objects;
generating data having a format including the image data and metadata for the image data; and
registering in the metadata an identifier for a user with respect to at least one of the image data and the object based on a user instruction.

15. The method according to claim 14, further comprising:
displaying a graphical user interface including at least a region for displaying the image data, a button for registering the identifier to the image data, and a button for registering the identifier to the object, and
registering in the metadata, based on an instruction issued by a user via the displayed graphical user interface, the identifier for the user with respect to at least one of the image data and the object.

16. The method according to claim 14, further comprising searching for image data or an object including a same identifier as an identifier designated by an operator based on the identifier registered in the data having the format.

17. The method according to claim 16, further comprising searching using a plurality of identifiers.

18. A computer-readable storage medium storing instructions which, when executed by an image processing apparatus, cause the image processing apparatus to perform operations comprising:
segmenting input image data into a plurality of objects;
generating data having a format including the image data and metadata for the image data; and
registering in the metadata an identifier for a user with respect to at least one of the image data and the object based on a user instruction.
